(19) United States
(12) Patent Application Publication
(10) Pub. No.: US 2024/0001987 A1
(43) Pub. Date: Jan. 4, 2024

(54) VEHICLE ACTIVE VIBRATION CONTROL SYSTEM AND METHOD

(71) Applicant: LORD Corporation, Cary, NC (US)

(72) Inventors: Mark Norris, Apex, NC (US); Florin Barbulescu, Fuquay Varina, NC (US); Martin Bieber, Apex, NC (US); Karl Kintz, Apex, NC (US)

(73) Assignee: LORD Corporation, Cary, NC (US)

(21) Appl. No.: 18/033,949

(22) PCT Filed: Oct. 28, 2021
(86) PCT No.: PCT/US2021/056923

§ 371 Date: Apr. 26, 2023

Related U.S. Application Data
(60) Provisional application No. 63/109,477, filed on Nov. 4, 2020.

(51) Int. Cl. B62D 7/22; F16F 15/00; B62D 33/06

(52) U.S. Cl. CPC B62D 7/224; F16F 15/002; B62D 33/0604; F16F 2230/18; F16F 2232/08

(57) ABSTRACT

A vehicle vibration control system (VCS) includes a vehicle having at least an engine, a transmission, a frame, a steering column with a steering wheel attached, a passenger cabin, and a controller area network (CAN) bus. The vibration and noise in the cabin and in or around steering column are bothersome to passengers in the passenger cabin. Linear force generators (LFGs) are used to control the noise and vibration in or around the steering column and/or steering wheel. Circular force generators (CFGs) are used to control noise and vibration in the passenger cabin. Sensors are used to measure the noise and vibration.

### CROSS-REFERENCE TO RELATED APPLICATIONS

The present application claims the benefit of U.S. Provisional Patent Application Ser. No. 63/109,477, filed on Nov. 4, 2020, the disclosure of which is incorporated herein by reference in its entirety.

### FIELD OF INVENTION/BACKGROUND

The subject matter disclosed herein generally relates to vibration control devices and methods for canceling vibrations and noise. More particularly, the subject matter disclosed herein relates to active vibration and noise control within automobiles and trucks by using force generators and accompanying methods for canceling vibrations and noise.

### BACKGROUND

For internal combustion engine vehicles, manufacturers are continuously trying to improve fuel efficiency. In some instances, the manufacturers intentionally force the vehicle's internal combustion engine to operate in an economy mode or “ECO mode” by using various techniques such as variable engine cylinder displacement control. When doing so, the ECO mode deactivates cylinders to save fuel. Unfortunately, vibration or noise is often created when one or more cylinders are deactivated. In addition, other methods may be employed to save fuel by manipulating the engine firing sequence, gear management, etc. Vibrations or noises created by these fuel saving actions may be transmitted to the driver and passengers.

Reducing the number of operating cylinders, changing the engine firing sequencing, and/or changing gears to save fuel may cause the driver and/or passengers to perceive any change in the normal vibration or noise as there being a problem with the internal combustion engine or the vehicle, even though everything is operating as designed. The driver's physical connection with the steering wheel may further amplify the perceived problem, as well as the driver's perception of the source of the vibration or noise. Thus, when fuel saving techniques are implemented on cars and trucks, an unacceptable vibration and noise may be experienced in the vehicle cab, at the seats, and in the steering column and steering wheel. One of the challenges in reducing the vibration and noise for one part of a vehicle is to avoid introducing vibration and noise into another part of the vehicle with the same vibration and noise canceling devices.

Hybrid vehicles operate with both an internal combustion engine and an electric motor. Hybrid vehicles may experience all the vibration and noise issues found in an internal combustion engine, plus hybrid vehicles may have added vibration and noise issues unique to the internal combustion engine and electric motor operations. For example, the switch-over between the internal combustion engine and electric motor may introduce vibrations and noise, or periodic vibrations possibly overshadowed by the internal combustion engine may be more distinct when operating with the electric motor. Additionally, some hybrid vehicles switch to the battery mode when stopped and during vehicle takeoff the internal combustion engine is started and may introduce sudden vibrations and noise. Thus, the same vibration and noise concerns of the internal combustion engine are present in the hybrid vehicle. In addition, the unique hybrid vehicle issues, and the potential issues associated with electric vehicles may also present vibration and noise problems.

What is needed is a vibration control system that reduces and/or eliminates unwanted vibrations and/or noise felt by the driver and passengers of a vehicle within the vehicle passenger cabin.

### SUMMARY OF THE INVENTION

In one aspect, a vibration control system (VCS) is provided for a steering column and/or steering wheel of a vehicle, with the steering column having a longitudinal X axis, a lateral Y axis, and a vertical Z axis, and with the steering wheel being coupled to the steering column. The VCS comprises at least one linear force generator (LFG), at least one vibration sensor, and a VCS controller. The at least one LFG being positioned within or coupled to the steering column, and aligned with one of the X, Y, or Z axes or aligned off-axis with one of a X₁, Y₁, or Z₁ axes. The at least one vibration sensor being capable of detecting vibration in or near the steering column and/or the steering wheel. The VCS controller being in electronic communication with the at least one LFG and the at least one vibration sensor. The VCS controller continuously analyzes data from the at least one vibration sensor, determining a vibration canceling force command, and continuously communicating the vibration canceling force command to the at least one LFG. In response to the vibration canceling force command, the at least one LFG generates at least one vibration or noise canceling force in its aligned axis.

In another aspect, a vibration control system (VCS) is provided for a vehicle that has an engine, a frame, a controller area network (CAN) bus, and a steering column positioned within a passenger cabin. The VCS comprises a plurality of circular force generators (CFGs), at least one linear force generator (LFG), vibration sensors, and at least one VCS controller. The plurality of CFGs are coupled to the frame of the vehicle. The at least one LFG is positioned within or coupled to the steering column, wherein the steering column has a longitudinal X axis, a lateral Y axis, and a vertical Z axis, and the at least one LFG is aligned with one of the X, Y, or Z axes or aligned off-axis with one of a X₁, Y₁, or Z₁ axes.

The vibration sensors include at least one vibration sensor positioned to continuously detect a vibration or noise from the engine and/or the frame, and at least one or more additional vibration sensors positioned to continuously detect vibration or noise on or within the steering column and/or a steering wheel. The steering wheel is coupled to the steering column.

The at least one VCS controller is in electronic communication with the CAN bus, the plurality of CFGs, the at least one LFG, and all vibration sensors. The VCS controller providing electronic control to the plurality of CFGs and the at least one LFG. The VCS controller continuously analyzes data from the CAN bus, all the vibration sensors, the plurality of CFGs, and the at least one LFG, and wherein the VCS controller calculates and communicates a vibration canceling force command for each of the plurality of CFGs and the at least one LFG. Each of the plurality of CFGs generates a vibration canceling force having a magnitude and a phase that attenuates the vibration and/or noise within the passenger cabin, and the VCS controller continuously updating and communicating vibration canceling force commands to each of the plurality of CFGs. The at least one LFG generates a linear vibration canceling force that attenuates the noise and/or vibration on or within the steering column and/or steering wheel, with the VCS controller continuously updating and communicating vibration canceling force commands to the at least one LFG.

In still another aspect, a method of controlling vibrations in a steering column positioned in a passenger cabin of a vehicle having an engine, a frame, and a controller area network (CAN) bus is provided. The method comprises integrating a vibration control system (VCS) with the steering column, the steering column having a longitudinal X axis, a lateral Y axis, and a vertical Z axis, the VCS including at least one linear force generator (LFG) positioned within or coupled to the steering column, the at least one LFG being aligned with one of the X, Y, or Z axes or aligned off-axis with one of a X₁, Y₁, or Z₁ axes. The VCS further including at least one vibration sensor capable of detecting vibration in the steering column, and a VCS controller in electronic communication with the at least one LFG, the at least one vibration sensor, and the CAN bus. The VCS controller continuously analyzes data from the at least one vibration sensor, the at least one LFG, and the CAN bus. The method further comprises detecting a vibration or noise with the at least one vibration sensor, communicating the detected vibrations or noise to the VCS controller, analyzing the detected vibration within the VCS controller, calculating a vibration canceling force command within the VCS controller, communicating the calculated vibration canceling force command from the VCS controller to the at least one LFG, generating the vibration canceling force with the at least one LFG in the LFG's aligned axis and canceling the detected vibration or noise, and continuously repeating.

### BRIEF DESCRIPTION OF THE DRAWINGS

FIG. 1 depicts a vehicle with a vibration control system (VCS) having both circular force generators (CFGs) and linear force generators (LFGs).

FIG. 2A is a perspective view of a steering column and steering wheel with LFGs aligned with the X, Y, and Z axes.

FIG. 2B is a perspective view of a steering column and steering wheel with LFGs aligned with the X₁, Y₁, and Z₁ axes, which are off axis from the X, Y, and Z axes of FIG. 2A.

FIG. 3 is a side view of a steering column and steering wheel with LFGs.

FIGS. 4A and 4B depict the electronic communication of the components of the VCS having LFGs.

FIGS. 5A-5C depict the electronic communication of the components of the VCS having LFGs and CFGs.

FIGS. 6A-6D depict a prior art circular force generator.

FIG. 7 illustrates test results using LFGs on a steering column when there is a vibration.

### DETAILED DESCRIPTION

As used herein, the terms automobile and vehicle are meant to address the entire spectrum of vehicles having an internal combustion engine running on combustible fuel such as gas, diesel, natural gas, hydrogen, etc., as well as hybrid vehicles having both an internal combustion engine and an electric motor. The use of the terms automobile and vehicle are meant to include, but not limited to passenger cars, light trucks, and medium-to-heavy trucks, including heavy, off-road vehicles. As used herein, the term engine is inclusive of an internal combustion engine. And, when applicable to a hybrid vehicle, the term engine used herein is inclusive of both an internal combustion engine and an electric motor. As used herein, the term transmission is meant to cover all references to a transmission, gears, drive unit, or other component transferring energy from the vehicle's engine directly or indirectly to the vehicle's wheels.

Vehicle vibrations and noise are generated by a variety of different components and dynamic forces in the vehicle such as the engine, transmission, frame, mechanical linkages, wheel assemblies, etc. and can be transmitted into the vehicle's passenger cabin. In some cases, the vibration and noise is transmitted through the steering column and/or steering wheel. The driver and passengers feel the vibrations and/or hear the noises. Vehicle manufacturers have tried to address the vibrations and noises by using several different technologies. One technology has been to use large linear force generators (LFGs) and circular force generators (CFGs) to mitigate the source of the vibrations and noise.

LFGs employ a rare earth magnet supported by a spring and they are driven by a voice coil via electromagnetic force. LFGs are designed without rotating bearings. The moving mass of the LFG creates a controllable dynamic linear force along an axis of the LFG to mitigate noise and vibration. LFGs are able to generate a dynamic linear force at multiple frequencies simultaneously. Thereby, the LFG is able to produce multiple frequency simultaneous vibration and noise control long the linear axis of the LFG.

Vehicle manufacturers have used large LFGs to address the large dynamic vibration and noise from the vehicle's engine, transmission, and/or frame. However, this requires the manufacturer to place large LFGs at different points on the vehicle frame for each vehicle model. Due to the different placement of the large LFGs, and because assembly lines have different vehicle models being manufactured on the same production line, changing the placement for each large LFG on each model slows down the production line.

Each large LFG must also be large enough to cancel the large dynamic vibration and noise from the engine, transmission, and/or frame. This increased size translates into significantly increased weight and power requirements for each LFG. Each large LFG is only able to produce a linear force along the axis of the LFG relative to its position on the vehicle. Thus, large LFGs are unable to control complex motions that are not along the LFG linear axis over a wide frequency range. Due to the size and extra weight of the large LFGs, the large volume of rare earth magnetic material and high-quality metals contained within each large LFG, the limitation of only producing linear force along the axis of the LFG, and the time it takes to change the placement of the LFG on the vehicle frame, increasingly makes the use of large LFGs an undesirable solution to address vibrations and noises.

Smaller LFGs have significantly lower weight, power, and cost constraints when compared to large LFGs. Thus, using smaller LFGs to control small vibrations and noises elsewhere in the vehicle, such as in the steering column and/or steering wheel, is advantageous over larger LFGs. These smaller LFGs are inherently quiet, generate a low audible noise signature, and are well suited to control vibration and noise in a confined space such as a vehicle passenger cabin. The form factor of smaller LFGs also provides more flexibility when mounting them to or within the steering column.

Instead of using smaller LFGs, small CFGs will also fit within the available space within the steering column. However, the spinning of the imbalance masses within the CFG may create an unwanted noise that can be bothersome to the driver and passengers. Thus, the use of smaller LFGs on or within the steering column and/or steering wheel provides a satisfactory lower noise solution than using small CFGs.

CFGs can generate a planar force and moment that can more easily control vibration in a complex structural response when compared to LFGs, especially over large ranges of operating frequencies. This makes CFGs ideal for mounting to a vehicle frame. Also, CFGs mounted to the frame are smaller and lighter than any LFGs used for the same purpose, and they do not need to be placed differently for each vehicle model. CFGs are also able to create larger forces than comparably sized LFGs. Thus, using CFGs on the frame to control vibration and noise transmitted to vehicle passenger cabin allows for canceling the large vibration or noise input to the occupants of the passenger cabin.

The system disclosed herein is a vibration control system (VCS) for a vehicle that has at least one vibration control force generator, along with at least one vibration/noise sensor and a VCS controller. The system is attached to or integrated with the vehicle. For the vibration control force generator, the VCS may have at least one LFG, at least one CFG, or a combination of at least one LFG and at least one CFG. Depending upon the vibrations and/or noise being controlled, the LFG and/or the CFG are positioned to control vibration and/or noise from a variety of vibration sources. The vibration sources may be from the engine, transmission, frame, steering column, and/or steering wheel, as well as other sources of vibration and noise.

The combination of LFGs and CFGs may simultaneously address vibration and noise from the frame and the steering column. The combination of LFGs and CFGs are ideal in many vehicle applications where CFGs are used to generate the larger forces required to control vibration and noise from the engine, transmission, frame, and the LFGs are used in locations where small controlling forces are required, such as within or on the steering column where a low operating vibration or noise is desired.

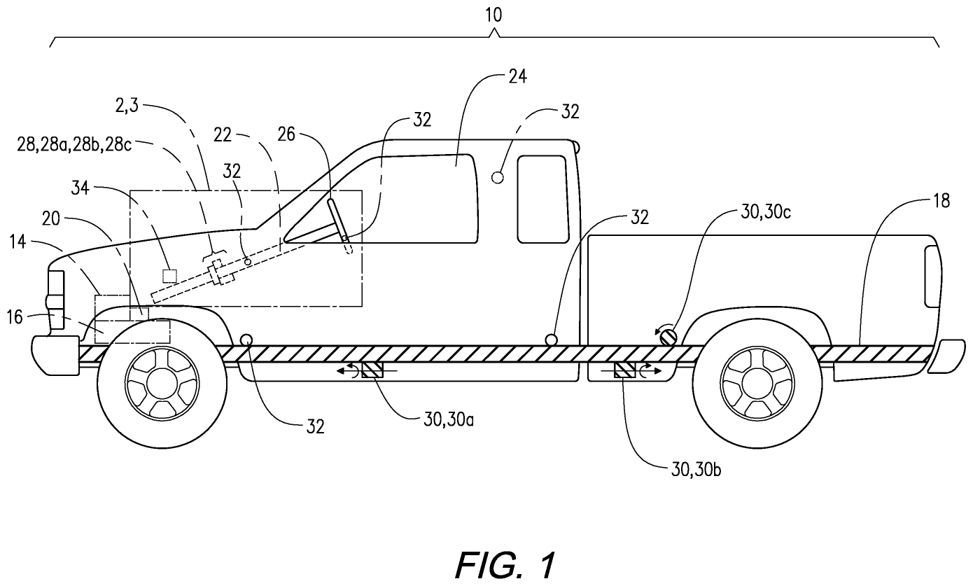

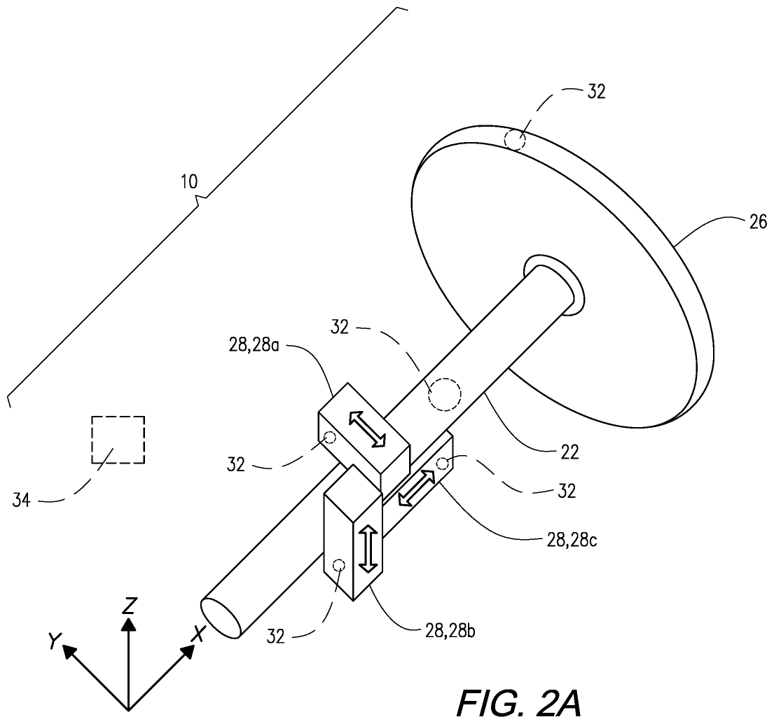

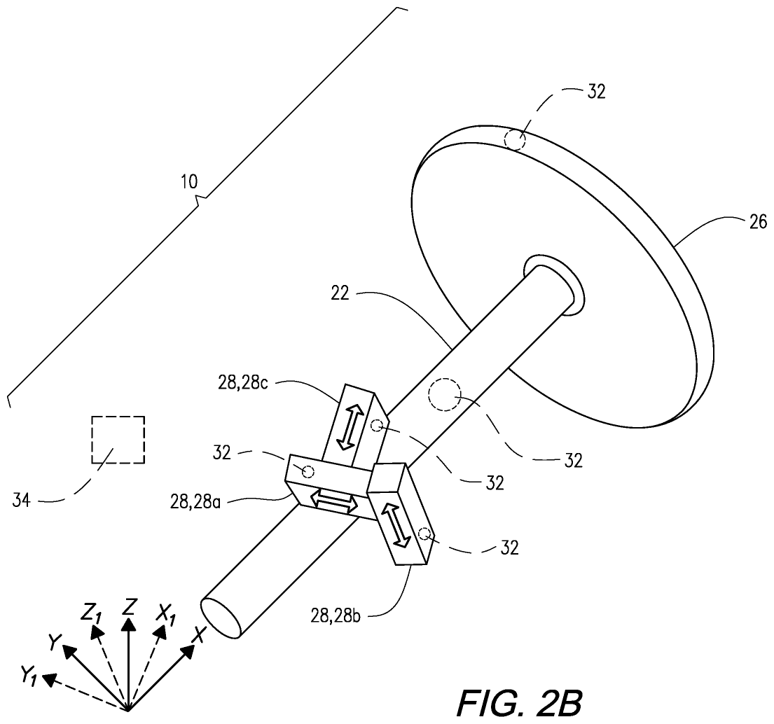

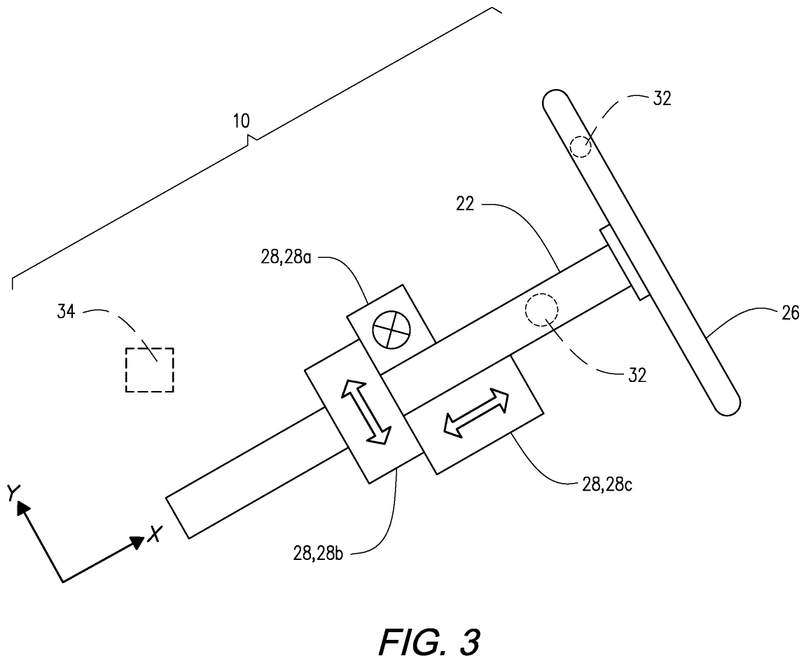

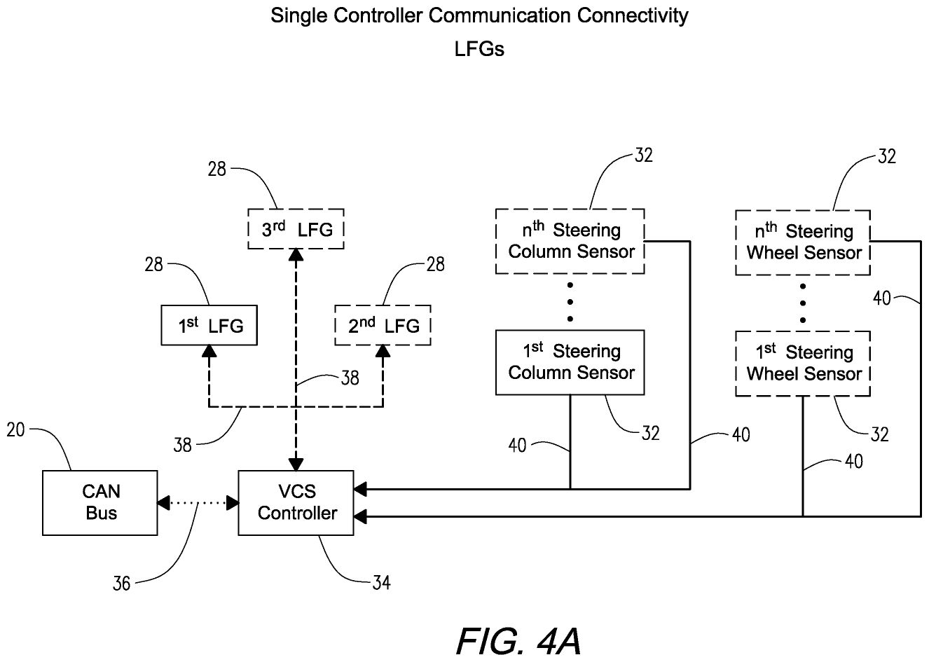

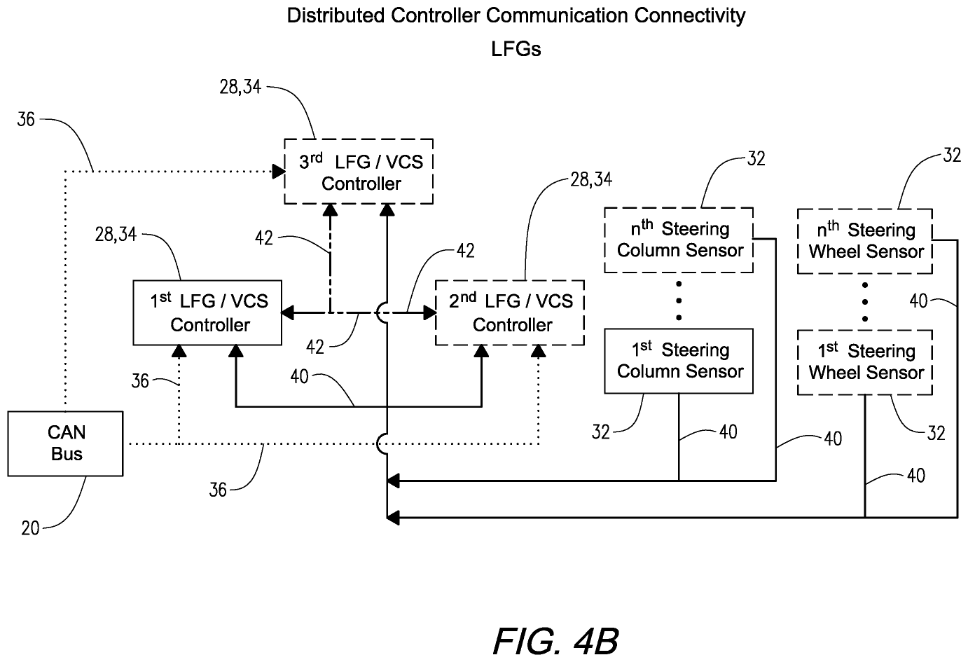

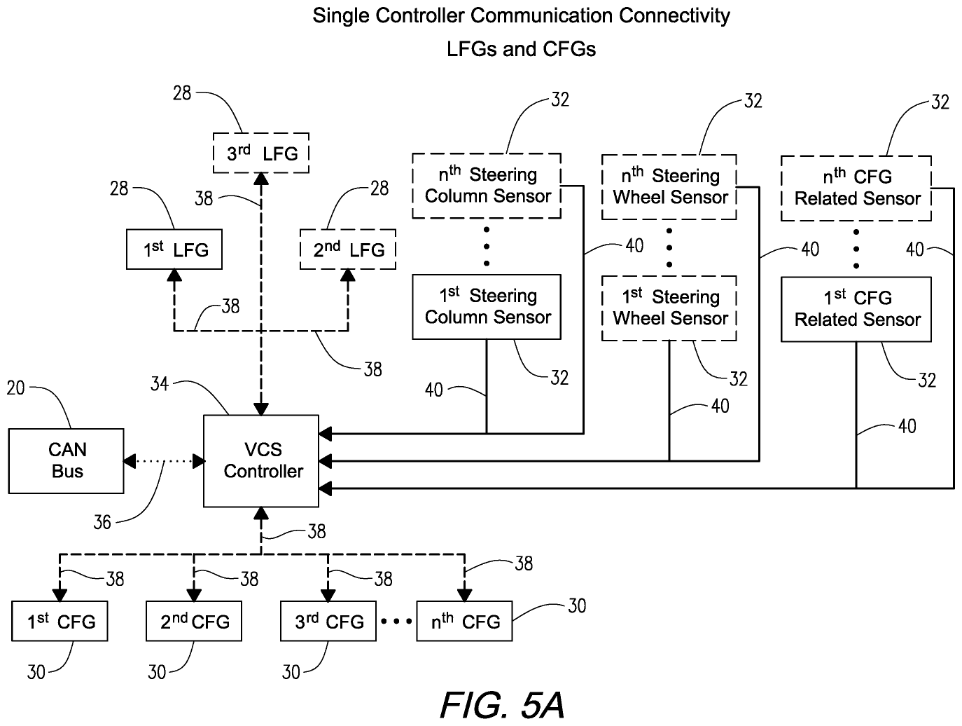

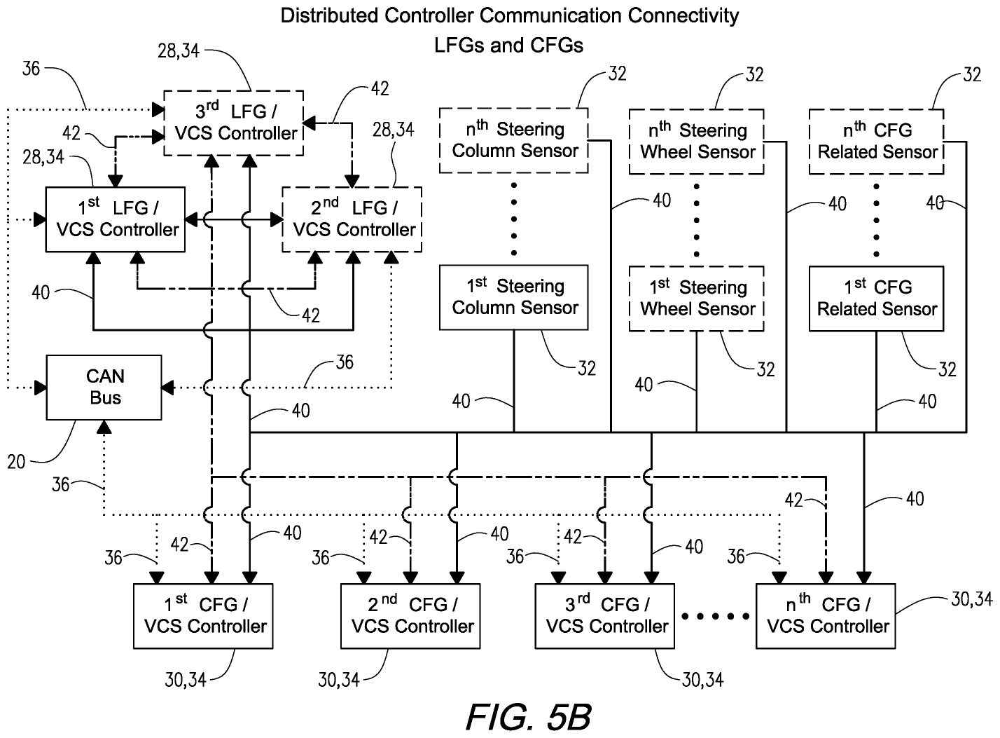

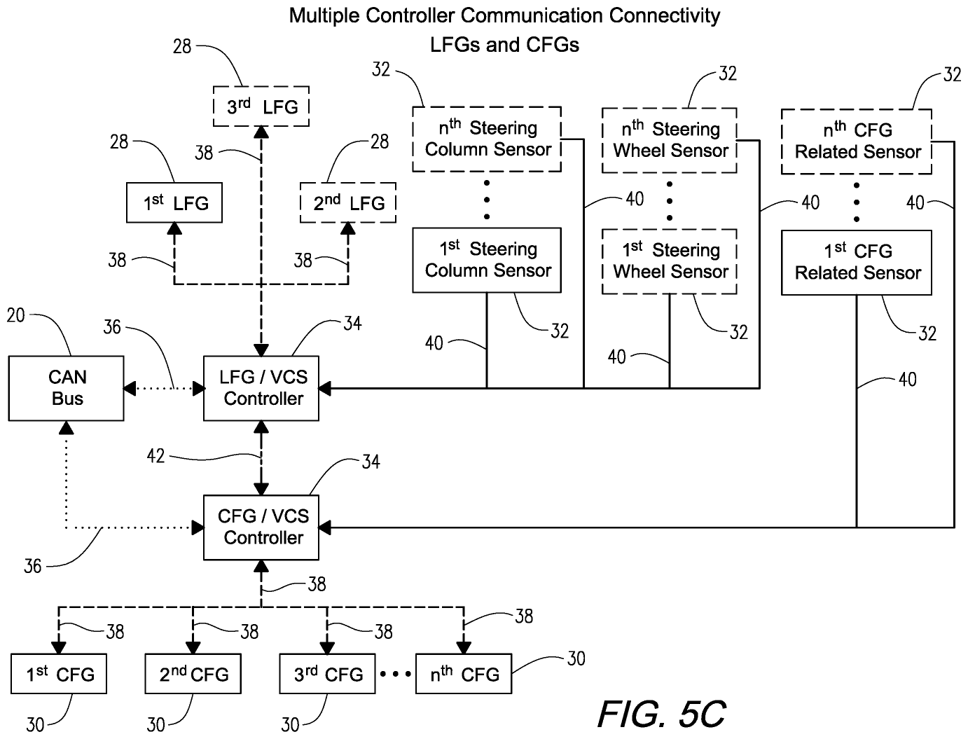

Referring to the drawings, FIGS. 1-3 depict a VCS 10 attached and/or integrated with a notional vehicle 12 having an engine 14, a transmission 16, a frame 18, a controller area network (CAN) bus 20, and a steering column 22 positioned within a passenger cabin 24. Steering column 22 has a steering wheel 26 attached to it to enable the operator of vehicle 12 to pilot it. In FIG. 1, VCS 10 has at least one LFG 28 and at least two CFGs 30, both of which are in direct or indirect electronic communication with vibration sensors 32 and VCS controller 34. FIGS. 2A-3 illustrate VCS 10 with at least one LFG 28 which is in direct or indirect electronic communication with vibration sensors 32 and VCS controller 34. Vibration sensors 32 are illustrated as being positioned at various locations on or in vehicle 12. As used herein, vibration sensor 32 may be a vibration sensor and/or a noise sensor. As discussed below, electronic communication between CAN bus 20, LFGs 28, CFGs 30, sensors 32, and VCS controller 34 is illustrated in FIGS. 4A-5C.

LFGs 28, 28a, 28b, 28c are illustrated in FIGS. 1-3. As described herein, at least one LFG 28 is used, with the addition of more LFGs 28 when there is a need for an increased level of vibration and/or noise control.

Power for LFGs 28, CFGs 30, sensors 32, and VCS controller 34 is provided by the vehicle power system (not shown) which may include a battery (not shown) and/or CAN bus 20. When CAN bus 20 is used, it may directly or indirectly supply power to LFGs 28, CFGs 30, vibration sensor 32, and VCS controller 34. Power may also be directly supplied from the vehicle to LFGs 28, CFGs 30, vibration sensor 32, and VCS controller 34. A combination of CAN bus 20 power and direct power from the vehicle power system may also be used.

Focusing VCS 10 without using any CFGs 30, VCS 10 is illustrated in FIGS. 2A-3 as using small, lightweight LFGs 28 to control small vibrations and noise in steering column 22 and or steering wheel 26. When the vibrations are uncontrolled, the driver may perceive these small vibrations to be a problem with engine 14, transmission 16, frame 18, or any number of possible vibration or noise input sources. The reference point for the vibration or noise being perceived is that of the occupants in passenger cabin 24 such as the driver or the passenger(s).

Referring to FIGS. 2A-3, VCS 10 is further illustrated with steering column 22 having a longitudinal X axis, a lateral Y axis, and a vertical Z axis. LFGs 28 are positioned within or coupled to steering column 22. Three LFGs 28 are illustrated in FIGS. 2A-3, however VCS 10 may only use one LFG 28 to operate. One of illustrated LFGs 28, 28a is aligned with one of X, Y, or Z axes. If a second LFG 28, 28b is used, then it is aligned with one of the two remaining X, Y, or Z axes. For example, one LFG 28, 28a may be aligned with the Y axis and the other LFG 28, 28b may be aligned with the Z axis. When a third LFG 28, 28c is included, that LFG 28, 28c is aligned with the remaining X, Y, or Z axis, whichever axis did not have any LFG 28 aligned with that axis. In FIGS. 2A and 3, each LFG 28 is aligned along one of the X, Y, and/or Z axes.

Although, LFGs 28a-28c are illustrated in FIGS. 2A and 3 as being associated with a particular X, Y, or Z axis, these orientations are for illustrations purposes only and are non-limiting. For example, FIG. 2B illustrates X₁, Y₁, and Z₁ axes as being off axis to the X, Y, and Z axes of FIG. 2A. For illustration purposes only, in FIG. 2B, one LFG 28, 28a is aligned with the Y₁ axis, LFT 28, 28b is aligned with the Z₁ axis, and LFG 28, 28c is aligned with the X₁ axis. As discussed, at least one LFG 28 is required. In FIG. 2B, each LFG 28 is aligned off-axis with one of the X₁, Y₁, and/or Z₁ axes.

Referring to FIGS. 2A-3, at least one vibration sensor 32 is positioned to detect vibration or noise from or in steering column 22 or steering column 26. The placement of vibration sensors 32 may be in one of, both of, or either steering column 22 or steering wheel 26. As illustrated, at least one vibration sensor 32 is positioned on or within steering column 22 and is capable of detecting vibrations or noise from or in the steering column 22. At least one other vibration sensor 32 is illustrated as being optionally positioned on or within steering wheel 26 and is capable of detecting vibrations or noise from or in the steering wheel 26. The number of vibration sensors 32 depicted in FIGS. 2A-3 as being associated with the steering column 22 or steering wheel 26 are for illustration purposes only and may include more sensors or less sensors. Additional vibration sensors 32 may be placed near steering column 22 and/or within passenger cabin 24.

Vibration sensor 32 selection depends upon the type of sensor and how many axes of vibration are being detected. In the non-limiting exemplary embodiment illustrated, at least two axes of vibration are being detected in steering column 22 and at least two axes of vibration are being detected in steering wheel 26. In an embodiment, vibration sensors 32 are selected from the group consisting of single axis vibration sensors, two-axis vibration sensors, three-axis vibration sensors, and combinations thereof. In another embodiment, at least one vibration sensor 32 is capable of detecting vibration and/or noise in two of three axes. In still another embodiment, at least one vibration sensor 32 is capable of detecting vibration and/or noise in two of three axes in steering column 22.

Sensors 32 may be any type of vibration or noise sensor to include but not be limited to accelerometers, biaxial sensors, inertial sensors, displacement sensors, piezoelectric sensors, strain gauges, acoustic sensors, microphones, etc. The embodiments may include the use of one or more different types of vibration sensors 32 at one or more locations on or within steering column 22 and/or steering wheel 26. Additionally, the embodiments may include the use of a single vibration sensor 32 at a single location in or on steering column 22 or steering wheel 26. The foregoing vibration sensors 32 are positioned away from LFGs 28. However, for production efficiencies it may be desirable to position vibration sensors 32 integrally on or within LFGs 28, as is illustrated in FIGS. 2A and 2B. In this case, one or more of the LFGs 28 will have at least one vibration sensor 32 integrated therewith. Vibration sensors 32 may be wired or wireless sensors.

VCS controller 34 is in electronic communication with CAN bus 20. In addition to being in electronic communication with CAN bus 20, VCS controller 34 is in electronic communication with each LFG 28 and with each vibration sensor 32. VCS controller 34 continuously analyzes data electronically communicated from each vibration sensor 32, determines a vibration canceling force command, and continuously communicates the vibration canceling force command to each LFG 28. Each LFG 28 generates a vibration or noise canceling force in its aligned axis in response to the vibration canceling force command.

Although a single VCS controller 34 is illustrated in FIGS. 2A-3, a plurality of VCS controllers 34 may be used when there is more than one LFG 28. In a non-limiting example, a distributed VCS controller 34 may be used. In this case, each LFG 28 has its own VCS controller 34 that is in electronic communication with each of the other VCS controllers 34, vibration sensors 32, LFGs 28, and CAN bus 20. In another non-limiting example, at least two separate VCS controllers 34 are used and are in electronic communication with each other as well vibration sensors 32, LFGs 28, and CAN bus 20. When more than one VCS controller 34 is used, one of the VCS controllers 34 is a dominate controller and each of the other VCS controllers 34 will be subordinate. Alternatively, each VCS controller 34 may operate independently, but each shall communicate with the vehicle via CAN bus 20 and/or directly with each of the other VCS controllers 34.

Referring to FIG. 1, VCS 10 is illustrated as combining at least one LFG 28 and at least two CFGs 30 to reduce the vibration and noise experienced by the driver and passengers within passenger cabin 24. Although two CFGs 30 are shown, only one CFG 30 is required for the combined LFG 28 and CFG 30 example. LFG 28 provides vibration control of vibration and noise transmitted to or through steering column 22 and/or steering wheel 26 and CFG 30 provides vibration control of vibration and noise transmitted to or through passenger cabin 24 from the vibration sources. LFG 28 and CFGs 30 work together to control vibration and noise.

LFG 28 components are placed and operate as described above and illustrated in FIGS. 2-4B. As illustrated in FIG. 1, LFGs 28 and CFGs 30 share the same VCS controller 34. However, more than one VCS controller 34 may be used. A VCS controller 34 associated with only LFGs 28 and another VCS controller 34 associated with only CFGs 30 may be used. A VCS controller 34 for each LFG 28 and/or for each CFG 30 may be used. When more than one VCS controller 34 is used, the VCS controller 34 may be a distributed system with a dominate and subordinate VCS controller 34.

In general, CFGs 30 can be placed at any location on vehicle 12, and the number and location of CFGs 30 are selected to meet vibration and noise canceling needs for individual vehicle types. In the non-limiting examples of FIG. 1, at least two CFGs 30 are illustrated with first CFG 30a and second CFG 30b shown as being mounted to frame 18 in opposite directions along the length of vehicle 12 such that controllable force is in the direction of frame 18 of vehicle 12. As illustrated, optional third CFG 30c is mounted perpendicular to first CFG 30a and second CFG 30b along a width of vehicle 12. At least one CFG 30 is necessary to control vibration and noise. CFGs 30 may be identical or one or more CFG 30 one may be different from the other(s). CFGs 30 may be coupled to frame 18 or any other structure of vehicle 12 in any orientation relative to each other. Each CFG 30 can generate a different magnitude force and/or relative phase based upon the vibration canceling force command received from VCS controller 34. However, the orientation and location of CFGs 30 must be able to produce a vibration canceling force capable of canceling vibration and noise in passenger cabin 24.

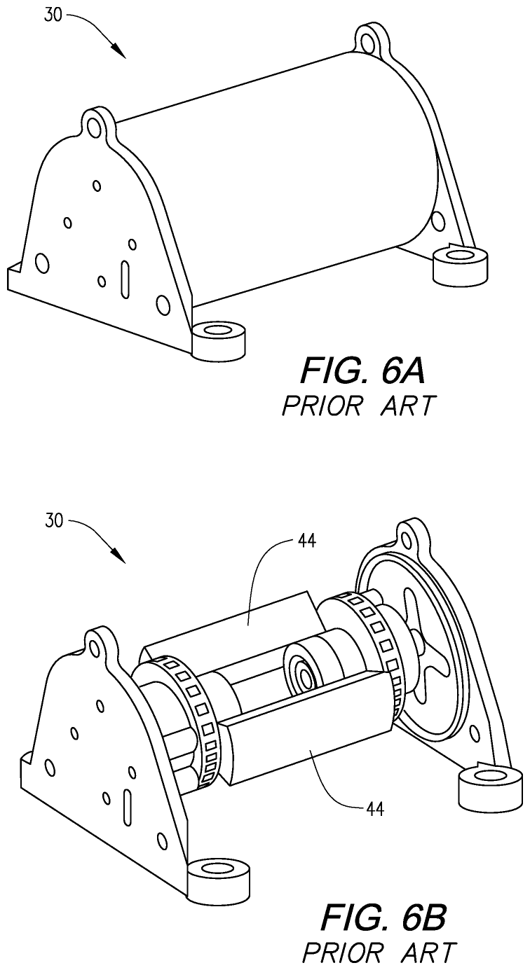

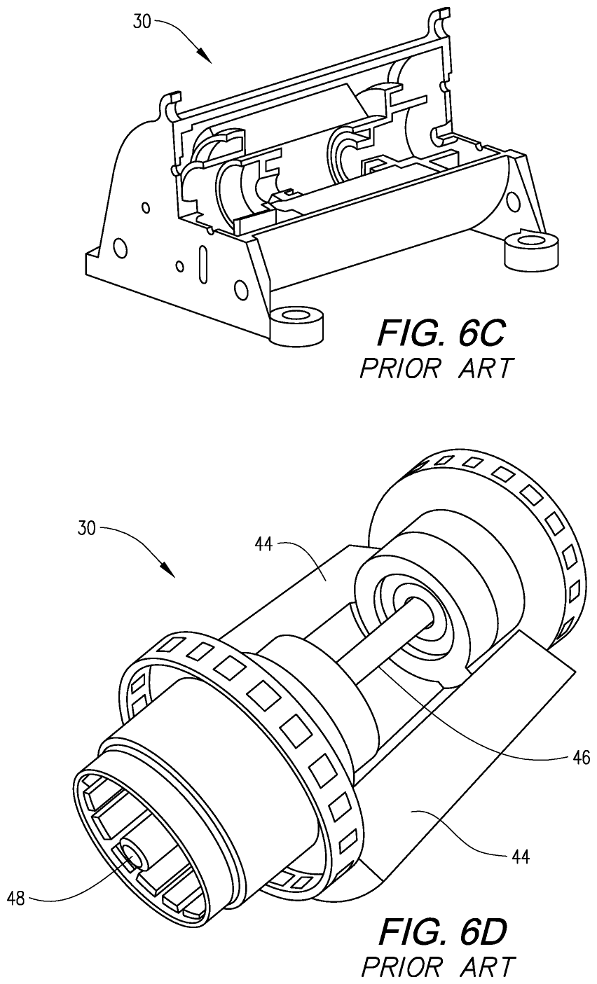

CFG designs vary. FIGS. 6A-6D illustrate a non-limiting prior art example of CFG 30. CFG 30 typically includes at least two rotating imbalance masses 44, a motor (not shown) for each imbalance mass 44, and the associated electronics and software/firmware (not shown) to generate a vibration canceling force having a magnitude and relative phase. The motor drives each of the imbalance masses 44 on shaft 46 and about a center axis 48 of CFG 30. The associated electronics and software/firmware guiding the circular rotation of the imbalance masses 44 provide for a controllable force having a magnitude and relative phase.

The non-limiting examples of prior art CFGs illustrated in FIGS. 6A-6D are presented for illustration purposes only. Specific designs of CFGs 30 are not part of this disclosure since those having skill in the relevant art are able to select the CFG 30 that is best for their intended purpose. Each prior art CFG 30 in FIGS. 6A-6D has a controller (not shown) directly and/or indirectly associated with it. There may be one controller for a plurality of CFGs 30 or there may be a controller for each CFG 30.

Vibration sensors 32 for CFGs 30 are illustrated in FIG. 1 as being positioned in passenger cabin 24. However, vibration sensors 32 can be placed anywhere that will provide data on the vibration and noise the driver and/or passengers may experience. For example, some vibration sensors 32 may be on frame 18. Other sensors may be positioned on, in or near a seat (not shown), a floorboard (not shown), in the headliner (not shown), or any other place providing vibration and noise data to electronically communicate with VCS controller 34. Vibration sensors 32 may be positioned integrally on or within LFGs 28 and/or CFGs 30. FIGS. 2A and 2B illustrate vibration sensors 32 integrally positioned on or within LFGs 28. Although not illustrated, vibration sensors 32 may also be integrally positioned on or within CFGs 30.

As described above, in addition to being in electronic communication with each LFG 28, each vibration sensor 32, and CAN bus 20, VCS controller 34 is in electronic communication with each CFG 30. Using the data it receives from all electronic communication, the VCS controller 34 calculates a vibration canceling force command for each LFG 28 and each CFG 30 to enable each LFG 28 and each CFG 30 to generate the vibration canceling force.

In operation with both LFGs 28 and CFGs 30, vibration sensors 32 in electronic communication with at least one LFG 28 detect a noise or vibration such as those measuring vibration and noise in or around steering column 22 and/or steering wheel 26. Vibration sensors 32 in electronic communication with CFGs 30 detect a noise or vibration such as those measuring vibration and noise in passenger cabin 24 as well as vibrations and noise from engine 14, transmission 16, frame 18, and/or any other source of vibration and noise generated on or by vehicle 12. Vibration sensors 32 transmit the detected noise or vibration to VCS controllers 34. VCS controller(s) 34 analyze the electronically communicated data from each vibration sensor 32 and CAN bus 20. Using vibration canceling algorithms known to those having skill in the art (e.g., Filtered-X algorithm, etc.), VCS controller(s) 34 calculate vibration or noise canceling force command(s) and transmit the vibration or noise canceling force command(s) to the at least one LFG 28 and/or CFGs 30. VCS controller(s) 34 calculate if LFG 28 or CFGs 30 need to generate simultaneous vibration and/or noise canceling forces in multiple frequencies. Upon receiving the vibration or noise canceling force command(s), each LFG 28, when there is more than one LFG 28, and/or each CFG 30 generates one or more vibration or noise canceling forces in its aligned axis. The process is continuously repeated.

Referring to FIGS. 4A-5C, the electronic communications between VCS controller(s) 34, CAN bus 20, vibration sensor(s) 32, LFGs 28, and CFGs 30 (collectively, the connected elements) are illustrated. FIGS. 4A and 4B only include LFGs 20, whereas FIGS. include both LFGs 28 and CFGs 30. One-way and two-way communications may be over a wired or wireless communication path (neither shown) that is capable of providing data to and/or from the connected elements as well as providing power. Power may be directly or indirectly provided to LFGs 28, CFGs 30, vibration sensor(s) 32, and VCS controller(s) 34 by CAN bus 20 and/or from vehicle power system (not shown).

Referring to FIG. 4A, the connected elements are illustrated as including at least one LFG 28 and do not include any CFGs 30. The second and third LFGs 28 and any additional vibration sensors 32 are illustrated as optional. There is a single VCS controller 34 illustrated in FIG. 4A. Two-way electronic communication 36 between VCS controller 34 and CAN bus and two-way communication 38 between VCS controller 34 and LFGs 28 are illustrated. There is one-way communication 40 between VCS controller 34 and vibration sensors 32.

The system illustrated in FIG. 4B is similar to the system illustrated in FIG. 4A, except each LFG 28 has its own VCS controller 34. As illustrated in FIG. 4B, each LFG 28 has its own VCS controller 34 with distributed electronic communications between each of them. In this case, the plurality of VCS controllers 34 are also in two-way electronic communication 42 with each other. Each VCS controller 34 is in electronic communication 36 with CAN bus 20, vibration sensors 32, all LFGs 28, and all other VCS controllers 34. Additionally, there is two-way electronic communication 36 between all VCS controllers 34 and CAN bus 20. Two-way electronic communication between each VCS controller 34 and its associated LFGs 28 is not illustrated in FIG. 4B. There is also one-way communication 40 between all VCS controllers 34 and all vibration sensors 32. When VCS controllers 34 are distributed, one of the VCS controllers 34 is the dominate controller and each of the other VCS controllers 34 will be subordinate. With a dominate/subordinate VCS controller 34 electronic communication may be direct or indirect to LFGs 28.

Referring to FIG. 5A, the connected elements include as least one LFG 28 and at least two CFGs 30. In FIG. 5A, except for the number of LFGs 28, everything described in FIGS. 4A and/or 4B is the same. The second and third LFGs 28, the third through n^{th} CFGs and the additional vibration sensors 32 are illustrated as being optional. There is two-way electronic communication 36 between VCS controller 34 and CAN bus 20. There is two-way communication 38 between VCS controller 34 and LFGs 28, and VCS controller 34 and CFGs 30. There is one-way communication 40 between VCS controller 34 and all vibration sensors 32.

Referring to FIG. 5B, the system is the same as in FIG. 5A except there is one VCS controller 34 for each LFG 28 and one VCS controller 34 for each CFG 30. In this illustration, the VCS controllers 34 are distributed meaning each LFG 38 and each CFG 30 has its own VCS controller 34. Each VCS controller 34 is in electronic communication 36 with CAN bus vibration sensors 32, all LFGs 28, all CFGs 30, and all other VCS controllers 34. There is two-way electronic communication 42 between all VCS controllers 34. Additionally, there is two-way electronic communication 36 between all VCS controllers 34 and CAN bus 20. Due to the simplification of the illustrated VCS 10 in FIG. 5B, the two-way electronic communication between all VCS controllers 34 and all LFGs 28 and between all VCS controllers 34 and all CFGs 30 are not illustrated in FIG. 5B. There is also one-way communication 40 between all VCS controllers 34 and all vibration sensors 32. When VCS controller 34 is distributed, one of the VCS controllers 34 is the dominate controller and each of the other VCS controllers are subordinate. With a dominate/subordinate VCS controller 34, electronic communication may be direct or indirect to LFGs 28 and CFGs 30.

Referring to FIG. 5C, the system illustrated has a single VCS controller 34 for LFGs 28 and a single VCS controller 34 for CFGs 30. In FIG. 5C there is two-way communication is between each of the VCS controllers 34. In one embodiment CFG VCS controller 34 is dominate over the LFG VCS controller 34. In another embodiment, LFG VCS controller 34 is dominate over the CFG VCS controller 34. In still another embodiment, CFG VCS controller 34 and LFG VCS controller 34 are independent, but share data.

Although not illustrated, other combinations of VCS controllers 34 providing control to LFGs 28 and CFGs 30 include a VCS controller 34 associated with each CFG 30 and one VCS controller 34 associated all LFGs 28. Similarly, a VCS controller 34 associated with each LFG 28 and one VCS controller 34 associated all CFGs 30 may be used. In either of these cases, VCS controllers 34 may be in a distributed dominate/subordinate configuration and all have two-way communication between them. Variations of these non-illustrated configurations of VCS controllers 34 may also be used.

Referring still to FIGS. 4A-5C, the operation of VCS 10 includes CAN bus 20 electronically communicating with VCS controller(s) 34. CAN bus 20 communicates vehicle information such as tachometer data, engine firing sequence (while an internal combustion engine is being used), transmission shift commands, etc. The tachometer information is used to by VCS controller(s) 34 to ensure that LFG(s) 28 generate a vibration canceling force that is synchronized to the engine tachometer (e.g., as non-limiting example two times per revolution of engine 14). VCS controller 34 is synchronized with the vehicle information to control the vibration canceling force generated so that the canceling forces from VCS 10 are synchronized with the current engine 14 operations. The synchronization may include the speed of the vehicle and be configured to generate a vibration canceling force as a hybrid vehicle switches operation between the electric motor and internal combustion engine 14. CAN bus 20 also communicates real-time or advanced data on engine 14 performance, such as when engine 14 is going into an ECO mode or switching between electric and internal combustion. ECO mode on internal combustion engines will deactivate cylinders to save fuel. Additionally, CAN bus 20 provides real-time or advanced data when a gear shift event is occurring or will occur in transmission 16. The resulting actions of engine 14 or transmission 16 from the vehicle computer (not shown) commands via CAN bus 20 may take a few milliseconds. VCS controller 34 also receives the vehicle computer commands via CAN bus 20. When VCS controller 34 receives this information, it uses CAN bus 20 data and combines it with data from vibration sensors 32 to calculate vibration canceling force commands.

When used with CFGs 30, VCS 10 at least two CFGs 30 and VCS controller 34 communicate with vibration sensors 32 and vehicle computer (not shown) commands via CAN bus 20 detect and generate vibration canceling forces. The resulting vibration canceling forces from CFGs 30 reduce the vibration and noise experienced by the driver and passengers within passenger cabin.

VCS 10 operates in a closed loop system or an open loop system. A closed loop system relies upon data from vibration sensors 32. In addition to relying upon vibration sensors 32, an open loop system also requires populating or entering data in VCS controller 34 related to various vehicle 12 performance and operating conditions.

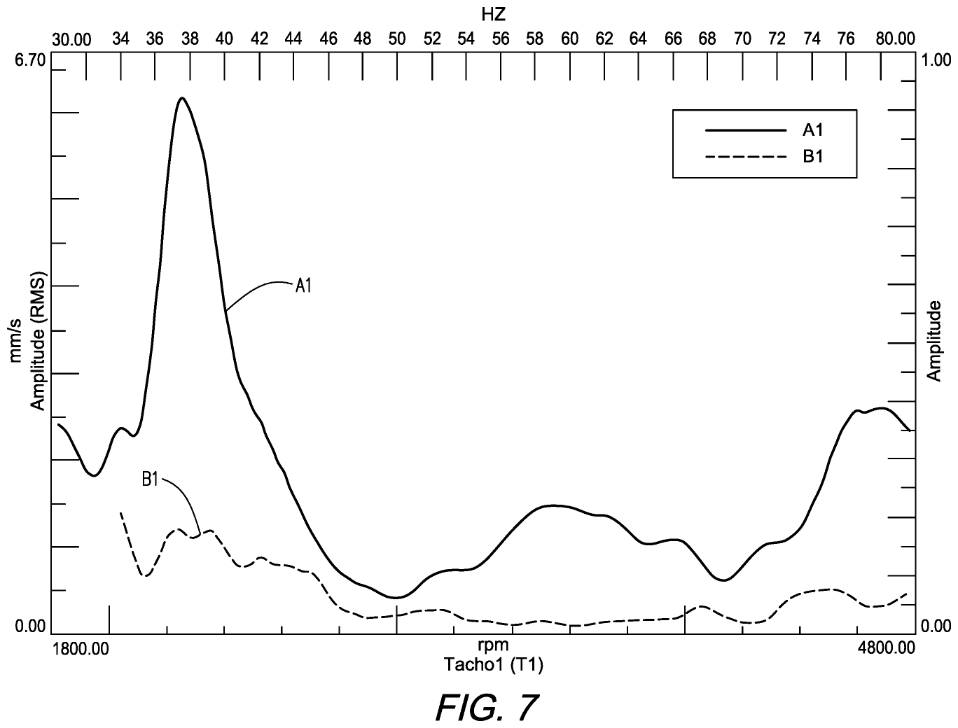

A test vehicle (not shown) was configured with VCS 10 having only two LFGs 28. The results of the tests are illustrated in FIG. 7. Referring to FIG. 7, line trace A1 represents vibration amplitude detected in the steering wheel of a test vehicle over a range of engine revolutions per minute (RPM) and frequency (Hz). Line trace B¹ represents the detected vibrations of the same steering wheel with two LFGs 28 operating. The bottom axis of FIG. 7 is the engine RPM, and the top axis is the vibrational frequency. FIG. 7 has the measured amplitude of the vibration on the left axis in millimeters per second (mm/s) as a root means square average of the vibration in the vehicle's longitudinal, lateral, and vertical axes (X, Y, and Z axes), and the right axis is the normalized value of the vibration amplitude in a range between zero and 1.0. The evidence from the testing illustrates a notable drop in vibrations at the steering wheel when the LFGs 28 are employed.

Other embodiments of the present invention will be apparent to one skilled in the art. As such, the foregoing description merely enables and describes the general uses and methods of the present invention. Accordingly, the following claims define the true scope of the present invention.

1. A vibration control system (VCS) for a steering column and/or steering wheel of a vehicle, the steering column having a longitudinal X axis, a lateral Y axis, and a vertical Z axis, the steering wheel coupled to the steering column, the VCS comprising:
at least one linear force generator (LFG) positioned within or coupled to the steering column, the at least one LFG aligned with one of the X, Y, or Z axes or aligned off-axis with one of a X₁, Y₁, or Z₁ axes;
at least one vibration sensor capable of detecting a vibration in or near the steering column and/or the steering wheel;
a VCS controller in electronic communication with the at least one LFG and the at least one vibration sensor, the VCS controller continuously analyzing data from the at least one vibration sensor, determining a vibration canceling force command, and continuously communicating the vibration canceling force command to the at least one LFG; and
wherein in response to the vibration canceling force command the at least one LFG generates at least one vibration or noise canceling force in its aligned axis.

2. The VCS of claim 1, wherein the VCS further comprises at least two LFGs, wherein a second LFG is aligned with one of the two remaining X, Y, or Z axes or aligned off-axis with one of the two remaining X₁, Y₁, or Z₁ axes.

3. The VCS of claim 2, wherein each of the at least two LFGs is capable of simultaneously controlling the vibration and a noise in multiple frequencies.

4. The VCS of claim 2, wherein each LFG has at least one vibration sensor integrated therewith.

5. The VCS of claim 2, further comprising a plurality of VCS controllers, wherein each LFG (28) has a VCS controller associated therewith, wherein all VCS controllers are in electronic communication with each other, with each LFG, and with each vibration sensor.

6. The VCS of claim 2, further comprising a distributed electronic communication between each of the at least two LFGs.

7. The VCS of claim 3, further comprising at least three LFGs, wherein a third LFG is aligned with the remaining X, Y, or Z axis or aligned off-axis with the remaining X₁, Y₁, or Z₁ axis.

8. The VCS of claim 7, wherein each LFG has at least one vibration sensor (32) integrated therewith.

9. The VCS of claim 7, further comprising a plurality of VCS controllers, wherein each LFG has a VCS controller associated therewith, wherein all VCS controllers are in electronic communication with each other, with each LFG, and with each vibration sensor.

10. The VCS of claim 7, further comprising a distributed electronic communication between each of the at least three LFGs.

11. The VCS of claim 1, wherein vibration sensor is positioned on or within the steering column.

12. The VCS of claim 11, further comprising at least one additional vibration sensor positioned on or within the steering wheel.

13. The VCS of claim 1, wherein in vehicle further includes a control area network (CAN) bus, the at least one VCS controller in electronic communication with the CAN bus.

14. The VCS of claim 1, wherein the vibration sensors are selected from the group consisting of a single axis vibration sensors, a two-axis vibration sensors, a three-axis vibration sensors, and combinations thereof.

15. The VCS of claim 1, wherein at least one vibration sensor is capable of detecting the vibration and/or a noise in two of three axes.

16. A vibration control system (VCS) for a vehicle that has an engine, a frame, a controller area network (CAN) bus, and a steering column positioned within a passenger cabin (24), the VCS (10) comprising:
at least one circular force generator (CFG) coupled to the frame of the vehicle;
at least one linear force generator (LFG) positioned within or coupled to the steering column, wherein the steering column has a longitudinal X axis, a lateral Y axis, and a vertical Z axis, and the LFG is aligned with one of the X, Y, or Z axes or aligned off-axis with one of a X₁, Y₁, or Z₁ axes;
at least one vibration sensor positioned to continuously detect vibration or noise from the internal combustion engine (14) and/or the frame;
at least one or more additional vibration sensor positioned to continuously detect vibration or noise on or within the steering column and/or a steering wheel, the steering wheel being coupled to the steering column;
at least one VCS controller (34), the at least one VCS controller in direct or indirect electronic communication with the CAN bus, the at least one CFG, the at least one LFG, and all vibration sensors, and the VCS controller providing direct or indirect electronic control to the at least one CFG and the at least one LFGs;
wherein the VCS controller continuously analyzes data from the CAN bus, all the vibration sensors, the at least one CFG, and the at least one LFG, and wherein the VCS controller calculates and communicates a vibration canceling force command for each CFG and each LFG;
wherein the at least one CFG generates a vibration canceling force having a magnitude and a phase that attenuates the noise and/or vibration within the passenger cabin, the VCS controller continuously updating and communicating vibration canceling force commands to each CFG; and
wherein the at least one LFG generates a linear vibration canceling force that attenuates the noise and/or vibration on or within the steering column and/or steering wheel, the VCS controller continuously updating and communicating vibration canceling force commands to the at least one LFG.

17. The VCS of claim 16, wherein the at least one LFG is capable of simultaneously controlling vibration and noise in multiple frequencies.

18. The VCS of claim 16, wherein the vibration sensors are selected from the group consisting of single axis vibration sensors, two-axis vibration sensors, three-axis vibration sensors, and combinations thereof.

19. The VCS of claim 16, wherein at least one vibration sensor is capable of detecting vibration and/or noise in two of three axes.

20. The VCS of claim 16, wherein a second LFG is aligned with one of the two remaining X, Y, or Z axes or aligned off-axis with one of the two remaining X₁, Y₁, or Z₁ axes.

21. The VCS of claim 20, wherein a third LFG is aligned with the remaining X, Y, or Z axis or aligned off-axis with the remaining X₁, Y₁, or Z₁ axis.

22. The VCS of claim 21, wherein each LFG and each CFG have at least one vibration sensor integrated therewith.

23. The VCS of claim 21, further comprising a distributed electronic communication between each of the LFGs.

24. The VCS of claim 21, further comprising at least two CFGs.

25. The VCS of claim 24, further comprising a distributed electronic communication between each CFG and each LFG.

26. The VCS of claim 16, further comprising a distributed electronic communication between each of the plurality of CFGs.

27. The VCS of claim 26, wherein at least one vibration sensor is integral with at least one LFG and at least one vibration sensor is integral with at least one CFG.

28. The VCS of claim 16, further comprising at least one additional vibration sensor positioned on or in the steering wheel.

29. The VCS of claim 16, further comprising a plurality of VCS controllers.

30. The VCS of claim 29, wherein one VCS controller is dominate over each of the other VCS controllers.

31. A method of controlling vibrations in a steering column positioned in a passenger cabin of a vehicle having an internal combustion engine, a frame, a controller area network (CAN) bus, the method comprising:
integrating a vibration control system (VCS) with the steering column, the steering column having a longitudinal X axis, a lateral Y axis, and a vertical Z axis, the VCS including:
at least one linear force generator (LFG) positioned within or coupled to the steering column, the at least one LFGs aligned with one of the X, Y, or Z axes or aligned off-axis with one of a X₁, Y₁, or Z₁ axes;
at least one vibration sensor capable of detecting vibration in the steering column;
a VCS controller (34) in electronic communication with the at least one LFG, the at least one vibration sensor, and the CAN bus, the VCS controller continuously analyzing data from the at least one vibration sensor, the at least one LFG, and the CAN bus; and
detecting vibrations or noise with the at least one vibration sensor;
communicating the detected vibrations or noise to the VCS controller, the VCS controller analyzing the detected vibration, and calculating a vibration canceling force command;
communicating the calculated vibration canceling force command from the VCS controller to the at least one LFG;
generating the vibration canceling force with the at least one LFG in the LFG's aligned axis and canceling the detected vibration or noise; and
continuously repeating.

32. The method of claim 31, wherein the VCS further comprises at least a second LFG, the second LFG being aligned with one of the two remaining X, Y, Z axes or aligned off-axis with one of the two remaining X₁, Y₁, or Z₁ axes.

33. The method of claim 32, wherein the VCS further comprises at least a third LFG, the third LFG being aligned with one of the remaining X, Y, Z axes or aligned off-axis with one of the remaining X₁, Y₁, or Z₁ axes.

34. The method of claim 32, wherein the VCS further comprises at least one circular force generator (CFG) coupled to a frame of the vehicle.
